(19) United States
(12) Patent Application Publication
(10) Pub. No.: US 2026/0192273 A1
(43) Pub. Date: Jul. 9, 2026

(54) POST HEATING OF CELLULOSE-BASED EXPANDABLE MICROSPHERES

(71) Applicant: NOURYON CHEMICALS INTERNATIONAL B.V., Amsterdam (NL)

(72) Inventors: Bo ANDREASSON, Sundsvall (SE); Roel WIJTMANS, Sundsvall (SE); Ted SVENSSON, Sundsvall (SE); Malin NEJSTRÖM, Sundsvall (SE)

(73) Assignee: NOURYON CHEMICALS INTERNATIONAL B.V., Amsterdam (NL)

(21) Appl. No.: 19/124,054

(22) PCT Filed: Oct. 26, 2023
(86) PCT No.: PCT/EP2023/079995

§ 371 Date: Apr. 24, 2025

(30) Foreign Application Priority Data
Oct. 26, 2022 (EP) 22203923.2

(51) Int. Cl. B01J 13/04; B01J 13/12; B01J 13/20; C08J 9/18

(52) U.S. Cl. CPC B01J 13/043; B01J 13/12; B01J 13/20; C08J 9/18; C08J 2301/02

(57) ABSTRACT

The invention relates to storage stable thermally expandable microspheres comprising a polymeric shell surrounding a hollow core, wherein the hollow core comprises a blowing agent, and the polymeric shell comprises a carboxylate-functionalised cellulose, wherein the microspheres retain at least 80% of the original weight of blowing agent encapsulated in the microspheres after six months of storage under ambient conditions. The invention further relates to a process for preparing storage stable thermally expandable microspheres comprising a polymeric shell surrounding a hollow core, wherein the hollow core comprises a blowing agent, and the polymeric shell comprises a carboxylate-functionalised cellulose, the method comprising the following steps: (i) preparing thermally expandable microspheres comprising a polymeric shell surrounding a hollow core, wherein the hollow core comprises a blowing agent, and the polymeric shell comprises a carboxylate-functionalised cellulose; and (ii) subjecting the thermally expandable microspheres obtained in step (i) to a post heating treatment by heating the thermally expandable microspheres to a temperature of at least 40° C.

### TECHNICAL FIELD

The invention relates to thermally expandable microspheres made from cellulose-based biopolymers which retain at least 80% of the original weight of blowing agent encapsulated in the microspheres after six months of storage under ambient conditions as well to methods for producing such expandable microspheres.

### BACKGROUND ART

Thermally expandable microspheres are known in the art, and are described for example in U.S. Pat. No. 3,615,972, WO 00/37547 and WO2007/091960. A number of examples are sold under the trade name Expancel®. They can be expanded to form extremely low weight and low density fillers, and find use in applications such as foamed or low density resins, paints and coatings, cements, inks and crack fillers. Consumer products that often contain expandable microspheres include lightweight shoe soles (for example for running shoes), textured coverings such as wallpaper, solar reflective and insulating coatings, food packaging sealants, wine corks, artificial leather, foams for protective helmet liners, and automotive weather strips.

Thermally expandable polymer microspheres usually comprise a thermoplastic polymeric shell, with a hollow core comprising a blowing agent which expands on heating. Examples of blowing agents include low boiling hydrocarbons or halogenated hydrocarbons, which are liquid at room temperature, but which vapourise on heating. To produce expanded microspheres, the expandable microspheres are heated, such that the thermoplastic polymeric shell softens, and the blowing agent vapourises and expands, thus expanding the microsphere. Typically, the microsphere diameter can increase between 1.5 and 8 times during expansion. Expandable microspheres are marketed in various forms, e.g. as dry free-flowing particles, as aqueous slurry or as a partially dewatered wet cake.

Expandable microspheres can be produced by polymerizing ethylenically unsaturated monomers in the presence of a blowing agent, for example using a suspension-polymerisation process. Typical monomers include those based on acrylates, acrylonitriles, acrylamides, vinylidene dichloride and styrenes. A problem associated with such thermoplastic polymers is that they are typically derived from petrochemicals, and are not derived from sustainable sources. In addition, many polymers are non-biodegradable, or at least biodegrade so slowly that they risk cumulative build-up in the environment. Hence, expandable microspheres have been described, in which at least a portion of the monomers making up the thermoplastic shell are bio-based, being derivable from renewable sources.

For example, WO2019/043235 describes polymers comprising lactone monomers, WO2019/101749 describes copolymers comprising itaconate dialkylester monomers, and WO2020/099440 as well as WO2021/234010 A1 disclose thermally expandable microspheres made from cellulose-based biopolymers.

Expandable microspheres made from cellulose-based biopolymers have been found to be particularly desirable in view of biodegradability, supply situation of monomers from sustainable sources as well as expansion and performance properties of the microspheres.

However, there remain some issues concerning long-term storage of the unexpanded cellulose-based microspheres as it has been found that expansion performance of the unexpanded microspheres impairs over time to some extent due to the tendency of the unexpanded microsphere to lose encapsulated blowing agent over time, presumably by diffusion through the polymeric network of the microsphere's shell. This is undesirable as the unexpanded microspheres are normally produced at the manufacturer's premises, then shipped in larger batches to a customer and expanded by the customer step-by-step in smaller amounts according to needs. However, this means that parts of the larger batch of unexpanded microspheres originally shipped will be stored at the customer's premises for a non-foreseeable time period, often for months, such as up to three, or up to six months, or even longer.

Hence, there remains a need for expandable microspheres made from cellulose-based biopolymers which have an improved storage stability. For instance, it would be desirable if expandable microspheres made from cellulose-based biopolymers could be stored up to three months, preferably even up to six months, or even longer without significant impairment of expansion properties. It would be even more desirable if expandable microspheres made from cellulose-based biopolymers could be stored up to three months, preferably even up to six months, or even longer and nonetheless retain at least 80% of the original weight of blowing agent encapsulated in the microspheres. It would be even more desirable, if the cellulose-based biopolymers retain at least 85%, such as at least 90%, at least 95%, or even at least 98% of the original weight of blowing agent encapsulated in the microspheres when stored for six months or longer at ambient conditions.

The present invention is, therefore, directed to finding such expandable polymeric microspheres made from cellulose-based biopolymers which retain at least 80% of the original weight of blowing agent encapsulated in the microspheres after six months of storage under ambient conditions and a method for producing the same. It has been found that such microspheres can be efficiently produced by subjecting expandable microspheres made from cellulose-based biopolymers after their production to a post heating treatment.

### SUMMARY OF INVENTION

In a first aspect, the present invention is directed to storage stable thermally expandable microspheres comprising a polymeric shell surrounding a hollow core, wherein the hollow core comprises a blowing agent, and the polymeric shell comprises a carboxylate-functionalised cellulose, wherein the microspheres retain at least 80% of the original weight of blowing agent encapsulated in the microspheres after six months of storage under ambient conditions.

The present invention is further directed to a method for preparing storage stable thermally expandable microspheres comprising a polymeric shell surrounding a hollow core, wherein the hollow core comprises a blowing agent, and the polymeric shell comprises a carboxylate-functionalised cellulose, the method comprising the following steps: (i) preparing thermally expandable microspheres comprising a polymeric shell surrounding a hollow core, wherein the hollow core comprises a blowing agent, and the polymeric shell comprises a carboxylate-functionalised cellulose; and (ii) subjecting the thermally expandable microspheres obtained in step (i) to a post heating treatment by heating the thermally expandable microspheres to a temperature of at least 40° C.

The present invention is even further directed to storage stable thermally expandable microspheres obtained by the above method.

### BRIEF DESCRIPTION OF DRAWINGS

FIG. 1 illustrates the difference between a single core (FIG. 1A) and multi-core (FIG. 1B) microsphere.

FIG. 2 illustrates the influence of pyromellitic dianhydride (PMDA) or pyromellitic acid (PMA) on storage stability after a post heating treatment.

FIG. 3 illustrates an exemplary thermogram for determining the amount of blowing agent encapsulated in an exemplary microsphere.

### DESCRIPTION OF EMBODIMENTS

The present invention discloses storage stable thermally expandable microspheres comprising a polymeric shell surrounding a hollow core, wherein the hollow core comprises a blowing agent, and the polymeric shell comprises a carboxylate-functionalised cellulose, wherein the microspheres retain at least 80% of the original weight of blowing agent encapsulated in the microspheres after six months of storage under ambient conditions.

The expandable microspheres are based on a polymeric shell comprising a carboxylate-functionalised cellulose. The functional group is a carboxylate group, or more than one carboxylate group, which are typically selected from C₁ to C₁₂ carboxylates. Thus, the term “carboxylate-functionalised cellulose” means that the cellulose comprises at least one carboxylate group. The carboxylate moiety forms part of the link between the carboxylate functional group and the cellulose, i.e. the cellulose is linked to the carboxylate functional group via an ester link.

The polymeric shell can comprise or consist of one or more polymeric components, in which at least one component, more than one component or all polymeric components are selected from such carboxylate-functionalised celluloses. Where there the shell comprises polymers other than those described herein (i.e. carboxylate-functionalised cellulose), their content is typically less than 50 wt %, for example less than 30 wt %, or less than 10 wt %, such as 9 wt % or below, 5 wt % or below or even 2 wt % or below. These percentages are based on the total polymer content of the shell.

In embodiments, the carboxylate functional group on the carboxylate-functionalised cellulose can be represented by formula (1).

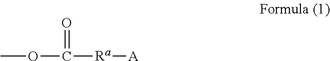

In Formula (1), A is selected from —H, —OH, —OR^{b}, —C(O)OH and —C(O)OR^{b}. In embodiments, A is selected from —H and —C(O)OH.

R^{a} can be absent, i.e. A can be directly attached to the C═O group. However, where present, R^{a} can be selected from saturated or unsaturated aliphatic groups having from 1 to 11 carbon atoms, and which can be linear, branched or cyclic.

R^{a} can also be selected from 5- and 6-membered aromatic rings.

R^{a} can optionally comprise one or more substituents selected from —OH, halide, C₁₋₄ alkyl, and C₁₋₄ alkoxy, where the C₁₋₄ alkyl and C₁₋₄ alkoxy groups are optionally substituted with one or more groups selected from halide and —OH.

R^{a} in embodiments comprises from 1 to 7 carbon atoms, for example from 1 to 5, or from 1 to 3 carbon atoms.

R^{b} on each occurrence is independently selected from a C₁₋₄ alkyl group, for example a C₁₋₂ alkyl group, optionally with one or more substituents selected from halide and —OH groups. In embodiments, the C₁₋₄ alkyl group or C₁₂ alkyl groups are unsubstituted.

In embodiments, R^{a} can be a saturated linear or branched aliphatic C_{y}R₂ᵥ^{c}, group or a cyclic C_{w}R_{2w-2}^{c} aliphatic group. v is an integer in the range of from 1 to 11, for example in the range of from 1 to 8, such as from 1 to 6 or from 1 to 4. w is an integer in the range of from 3 to 11, for example from 4 to 6.

R^{c} on each occurrence is independently selected from H, —OH, halide, C₁₋₄ alkyl, and C₁₋₄ alkoxy, where the C₁₋₄ alkyl and C₁₋₄ alkoxy groups are optionally substituted with one or more groups selected from halide and —OH.

In other embodiments, R^{a} can be an unsaturated linear or branched aliphatic CₓR_{2x-2y}^{c} group comprising “y” double bonds. x is an integer in the range of from 2 to 11, for example from 2 to 6 or from 2 to 4. y represents the number of double bonds, and is typically 1 or 2.

In further embodiments, R^{a} can be an unsaturated cyclic aliphatic C_{w}R_{2w-2y-2}^{c} group comprising “y” double bonds, where y is typically 1 or 2.

In still further embodiments, R^{a} can be a C_{z}R_{z-2}^{c} aromatic group. z is an integer selected from 5 and 6.

In still further embodiments, R^{a} can be a linear or branched aliphatic group comprising a cyclic aliphatic or aromatic ring. Thus, R^{a} can be a CₚR_{2p-2q}^{c}−E−CᵣR₂ᵣ₋₂ₛ^{c} group having no more than 11 carbon atoms, where E is C_{w}R_{2w-2}^{c}, C_{w}R_{2w-2y-2}^{c}, or C_{z}R_{z-2}^{c} as defined above. p and r are each independently a whole number from 0 to 8, where p+r is at least 1. q and s are each the number of double bonds in the respective non-cyclic aliphatic component. In embodiments, each of q and s are independently selected from 0, 1 and 2.

Halides are typically selected from F and Cl. In embodiments, however, the functional group is halide-free, such that there are no halides in groups A, R^{a}, R^{b} and R^{c}.

In embodiments, at least one R^{c} group is H. In other embodiments no more than two R^{c} groups are other than H, and in further embodiments, no more than one R^{c} group is other than H. In still further embodiments, all R^{c} groups are H.

In the above definitions of R^{a}, R^{b} and R^{c}, where there is more than one —OH substituent, there is typically no more than one —OH substituent per carbon atom.

In certain embodiments, R^{a} is an optionally substituted C₁-C₈ aliphatic (alkylene) group. In other embodiments, R^{a} is an optionally substituted C₆ aromatic ring. In further embodiments, R^{a} is unsubstituted.

In embodiments, the functional group on the cellulose substituent is selected from acetate, propionate, butyrate, pentanoate, hexanoate, heptanoate, octanoate and phthalate. In further embodiments, it is selected from acetate, propionate and butyrate, preferably from acetate. Hence, the carboxylate-functionalised cellulose is preferably an acetate-functionalised cellulose, a propionate-functionalised cellulose, or a butyrate-functionalised cellulose, and more preferably is an acetate-functionalised cellulose.

The degree of substitution (DS) of the hydroxyl groups of the cellulose by the one or more carboxylate groups can be in the range of from 0.9 to 3.5, and in embodiments is in the range of from 1.5 to 3.5, for example in the range of from 2.0 to 3.3.

Optionally, other functional groups may be present in the functionalised cellulose. For example, —OH groups on the cellulose molecule that are not already substituted with carboxylate-functionality can be replaced by an alkoxy group, or more than one alkoxy group, e.g. selected from C₁ to C₆ alkoxy groups. In other embodiments, although less preferred, the —OH group can be replaced with a halide group, for example F or Cl. Where such other functional groups are present, they are in lower molar quantities than the one or more carboxylate groups. In embodiments, the degree of substitution of the cellulose by other functional groups is no more than 1, for example no more than 0.5 or no more than 0.2. In further embodiments, the degree of substitution by groups other than carboxylate groups is no more than 0.1.

In embodiments, the carboxylate-functionalised cellulose comprises acetate, propionate, or butyrate groups, preferably acetate groups.

In embodiments, the cellulose can be functionalised with two or more different carboxylate groups. In some embodiments, the carboxylate-functionalised cellulose is functionalised with at least two, such as exactly two, different carboxylate functionalities which are carboxylate functionalities as described above. For instance, the carboxylate-functionalised cellulose may be functionalised with at least an acetate group and at least an additional group selected from propionate groups, butyrate groups, pentanoate groups, hexanoate groups, heptanoate groups, octanoate groups and phthalate groups. In some embodiments, the carboxylate-functionalised cellulose is functionalised with at least an acetate group and at least an additional group selected from butyrate groups and propionate groups (i.e. in the additional carboxylate groups, R^{a} is an aliphatic and unsubstituted C₂ or C₃ group, and A is H). For instance, the carboxylate-functionalised cellulose may be functionalised with an acetate group and a butyrate group, or the carboxylate-functionalised cellulose may be functionalised with an acetate group and a propionate group.

In embodiments, the glass transition temperature (T_{g}) of the functionalised cellulose that forms the shell of the microspheres or at least part of the shell of the microspheres is at least 80° C. The T_{g} can be measured using differential scanning calorimetry (DSC), for example using the method described by Nishio et al; Cellulose, 2006 (13), 245-259, in which 5 mg sample is heated for a first time at a rate of 20° C./min under a nitrogen atmosphere from ambient temperature (25° C.) to 240° C., and then immediately quenched to −50° C., before being heated for a second time from −50° C. to 240° C. at 20° C./min under a nitrogen atmosphere, the T_{g} calculation being based on the second heating cycle.

In further embodiments, the T_{g} of the carboxylate-functionalised cellulose is at least 90° C., for example at least 100° C., at least 110° C. or at least 120° C. In embodiments, the T_{g} of the carboxylate-functionalised cellulose is no more than 250° C., for example no more than 220° C., or no more than 200° C., or no more than 190° C., such as around 180° C. In embodiments, the T_{g} is in the range of from 80 to 250° C., for example in the range of from 90 to 220° C., from 100 to 200° C., or from 110 to 190° C. In further embodiments, the T_{g} is in the range of from 120 to 190° C., for example from 150 to 190° C. or from 170 to 190° C.

The melting point of the functionalised cellulose is typically above the T_{g} value, and in embodiments is above 125° C. In further embodiments, the melting point is above 150° C. The melting point is typically no more than 270° C., for example no more than 250° C.

The T_{g} and the melting point of the carboxylate-functionalised cellulose can be modified or controlled by varying the functional groups on the functionalised cellulose or by varying the molecular weight.

The thermally expandable microspheres are hollow, in which the shell comprises the carboxylate-functionalised cellulose, and the hollow centre or core comprises one or more blowing agents. The carboxylate-functionalised celluloses used to prepare the microspheres typically have a density of 1.1-1.35 g/cm³. In the expanded microspheres, the density is typically less than 1 g/cm³, and is suitably in the range of from 0.005 to 0.8 g/cm³, or from 0.01 to 0.6 g/cm³. In further embodiments, the density of the expanded microspheres is in the range of from 0.01 to 0.4 g/cm³. Higher densities, particularly densities of 1 g/cm³ or more, generally mean that the microsphere samples are not suitable for use.

In embodiments, the number average molecular weight (Mₙ) of the functionalised cellulose used to form the microspheres is in the range of from 1 000 to 700 000 Da, for example in the range of from 2 000 to 500 000 Da or in the range of 2 000 to 100 000 Da. In embodiments, it is in the range of from 10 000 to 100 000 Da, for example from 10 000 to 50 000 Da.

The thermally expandable microspheres may have a temperature at which expansion starts, T_{Start}, of from 80° C. to less than 250° C. The temperature at which expansion starts is called T_{Start}, while the temperature at which maximum expansion is reached is called Tₘₐₓ. T_{Start} and T_{Max} may be determined using standard measuring techniques as commonly known by the skilled person. For instance, T_{Start} and T_{MaX} can be determined in a temperature ramping experiment, by using for example a Mettler-Toledo Thermomechanical Analyser, such as Mettler-Toledo TMA/SDTA 841e, using a heating rate of 20° C./min and a load (net.) of 0.06 N.

In such a temperature ramping experiment, a sample of known weight of the thermally expandable microspheres is heated with a constant heating rate of 20° C./min under a load (net.) of 0.06 N. When expansion of the thermally expandable microspheres starts, the volume of the sample increases and moves the load upwards. From such measurement, an expansion thermogram is obtained wherein the ordinate indicates the height of moving the load upwards and the abscissa indicates the temperature. T_{Start} and T_{Max} can be determined from this expansion thermogram for instance by using STARe software from Mettler-Toledo.

In embodiments, the thermally expandable microspheres may have a T_{Start} in the range of from 90 to 220° C., such as for instance from 100 to 210° C., from 110 to 200° C., or from 115 to 190° C.

In preferred embodiments, the thermally expandable microspheres have a T_{Start} in the range of from 120 to 185° C.

To further enhance the properties of the polymer shell, the polymeric shell of the thermally expandable microspheres may comprise an anhydride-containing compound or a hydrogen bond donor selected from the group of alcohols, urea, and carboxylic acids, preferably an anhydride-containing compound or a hydrogen bond donor in the form of a carboxylic acid. For instance, the hydrogen bond donor may interact via hydrogen bonds with groups on the carboxylate-functionalised celluloses. By adding an anhydride-containing compound or a hydrogen bond donor selected from the group of alcohols, urea, and carboxylic acids, preferably an anhydride-containing compound or a hydrogen bond donor in the form of a carboxylic acid, it is possible to further improve the barrier properties of the polymer shell and to improve the mechanical properties of the polymer shell and thus the expansion properties of the microspheres. Thus, the hydrogen bond donor functions as a polymer shell enhancer.

The anhydride-containing compound or the hydrogen bond donor may be a polymer having for instance an average molecular weight of up to 10000 g/mol, such as from 1000 g/mol up to 5000 g/mol or from 1500 g/mol up to 3000 g/mol. The anhydride-containing compound or the hydrogen bond donor may also be, and the anhydride-containing compound or the hydrogen bond donor typically and preferably is, a low-molecular weight compound having for instance a molecular weight of less than 2000 g/mol, preferably less than 1500 g/mol, more preferably less than 1000 g/mol and even more preferably less than 500 g/mol. For instance, the anhydride-containing compound or the hydrogen bond donor may have a molecular weight in the range of 20 to 500 g/mol, preferably between 30 and 400 g/mol, and even more preferably between 40 and 300 g/mol.

Anhydride-containing compounds are compounds containing at least one anhydride group, such as at least two anhydride groups, or at least three anhydride groups. However, compounds containing exactly two anhydride groups (the “dianhydrides”) are preferred.

In embodiments, the anhydride-containing compound is preferably selected from the group consisting of 1,2,4,5-benzenetetracarboxylic dianhydride, benzophenone tetracarboxylic dianhydride, ethylene tetraacetic dianhydride, butane tetracarboxylic dianhydride, ethylenediamine tetraacetic dianydride, 3,3′,4,4′-biphenyltetracarboxylic dianhydride, bicyclo[2.2.2]oct-7-ene-2,3,5,6-tetracarboxylic dianhydride, cyclobutane-1,2,3,4-tetracarboxylic dianhydride, 4,4′-oxydiphthalic anhydride and tetrahydrofuran-2,3,4,5-tetracarboxylic dianhydride. More preferably the anhydride-containing compound is selected from the group consisting of 1,2,4,5-benzenetetracarboxylic dianhydride, benzophenone tetracarboxylic dianhydride and ethylene tetraacetic dianhydride, and even more preferably is 1,2,4,5-benzenetetracarboxylic dianhydride or benzophenone tetracarboxylic dianhydride. Particularly preferred is that the anhydride-containing compound is pyromellitic dianhydride (1,2,4,5-benzenetetracarboxylic dianhydride). 1,2,4,5-benzenetetracarboxylic dianhydride is also known as and referred herein to as pyromellitic dianhydride.

Hydrogen bond donors selected from the group of alcohols, urea, and carboxylic acids are compounds having hydrogen atoms covalently bound to a more electronegative atom, i.e. oxygen (if the hydrogen bond donor is an alcohol or a carboxylic acid) or nitrogen (if the hydrogen bond donor is urea), where these hydrogen atoms form intermolecular hydrogen bonds with functional groups (hydrogen bond acceptors) of the carboxylate-functionalised cellulose, such as the carboxylate functionalities or, if present, the one or more further, optional hydroxyl groups and ether groups.

The hydrogen bond donor is selected from the group of alcohols, urea, and carboxylic acids.

Preferably, the hydrogen bond donor is selected from the group of alcohols and carboxylic acids. In a more preferred embodiment, the hydrogen bond donor is a carboxylic acid. In another more preferred embodiment, the hydrogen bond donor is an alcohol.

The hydrogen bond donor selected from the group of alcohols, urea, and carboxylic acids, preferably the hydrogen bond donor in the form of a carboxylic acid, may have a molecular weight in the range of 20 to 2000 g/mol and preferably has a molecular weight in the range of 20 to 500 g/mol, more preferably between 30 and 400 g/mol, and even more preferably between 40 and 300 g/mol.

If the hydrogen bond donor is an alcohol, it may be selected from any compound containing at least one alcohol group, such as one, two, three, four, five or six alcohol groups, preferably having a molecular weight in the range of from 20 to 2000 g/mol. If the hydrogen bond donor is an alcohol, it is preferably a diol, triol, tetraol, pentaol or hexaol.

Suitable diols are for instance selected from 1,2-ethanediol, 1,2-propanediol, 1,3-propanediol, 1,2-butanediol, 1,3-butanediol, 2,3-butanediol, 1,4-butanediol, 1,2-pentanediol, 1,3-pentanediol, 1,4-pentanediol, 1,5-pentanediol, 1,2-hexanediol, 1,3-hexanediol, 1,4-hexanediol, 1,5-hexanediol, 1,6-hexanediol, 1,2-cyclohexanediol, 1,3-cyclohexanediol, and 1,4-cyclohexanediol, and is preferably 1,3-butanediol.

Suitable triols are for instance glycerol, 1,2,3-butanetriol, 1,2,4-butanetriol, 1,1,1-tris(hydroxymethyl)propane, pentanetriols, and hexanetriols. A preferred triol is glycerol.

Suitable tetraols are for instance ascorbic acid (Vitamin C), erythritol, threitol or pentaerythritol. Preferred tetraols are ascorbic acid (Vitamin C) and pentaerythritol.

Suitable pentaols are xylitol, arabitol, ribitol, glucose, fructose, galactose, and mannose.

Suitable hexaols are for instance sorbitol, mannitol, and cyclohexanehexol. A preferred hexaol is sorbitol.

If the hydrogen bond donor is an alcohol, it is preferably selected from 1,3-butanediol, glycerol, ascorbic acid (Vitamin C) or sorbitol.

The hydrogen bond donor is particularly preferably a carboxylic acid, i.e. a compound containing at least one carboxylic acid group, such as a monocarboxylic acid, a dicarboxylic acid, a tricarboxylic acid, a tetracarboxylic acid or a polycarboxylic acid, such as a polycarboxylic acid polymer. More particularly, the hydrogen bond donor is a carboxylic acid having a molecular weight in the range of from 20 to 2000 g/mol. Preferably the hydrogen bond donor is a carboxylic acid containing at least two carboxylic acid groups (—COOH), particularly a dicarboxylic acid, a tricarboxylic acid or a tetracarboxylic acid.

Examples of monocarboxylic acids are formic acid, acetic acid, propionic acid, butyric acid, valeric acid, caproic acid, benzoic acid, and lactic acid.

Examples of dicarboxylic acids are adipic acid, maleic acid, succinic acid, tartaric acid and aldaric acid.

Examples of tricarboxylic acids are citric acid and isocitric acid.

Examples of tetracarboxylic acids are pyromellitic acid (1,2,4,5-benzenetetracarboxylic acid), ethylenediaminetetraacetic acid (EDTA) and butanetetracarboxylic acids, such as 1,2,3,4-butanetetracarboxylic acid (BTCA).

Preferred examples of suitable hydrogen bond donors in the form of a carboxylic acid are citric acid, maleic acid, succinic acid, pyromellitic acid (1,2,4,5-benzenetetracarboxylic acid), lactic acid, tartaric acid, ethylenediaminetetraacetic acid (EDTA), butanetetracarboxylic acids, such as 1,2,3,4-butanetetracarboxylic acid (BTCA). Even more preferred examples of suitable hydrogen bond donors in the form of a carboxylic acid are pyromellitic acid (1,2,4,5-benzenetetracarboxylic acid), citric acid, tartaric acid, 1,2,3,4-butanetetracarboxylic acid (BTCA), and maleic acid.

Particularly, if the hydrogen bond donor is according to a preferred embodiment in the form of a carboxylic acid, it is selected from the group consisting of pyromellitic acid (1,2,4,5-benzenetetracarboxylic acid), citric acid, tartaric acid, 1,2,3,4-butanetetracarboxylic acid (BTCA), and maleic acid.

More particularly, if the hydrogen bond donor is according to a preferred embodiment in the form of a carboxylic acid, it is selected from the group consisting of pyromellitic acid (1,2,4,5-benzenetetracarboxylic acid), citric acid, tartaric acid, and 1,2,3,4-butanetetracarboxylic acid (BTCA).

Preferably, if the hydrogen bond donor is according to a preferred embodiment in the form of a carboxylic acid, it is a tricarboxylic acid or a tetracarboxylic acid, such as citric acid, pyromellitic acid (1,2,4,5-benzenetetracarboxylic acid) or 1,2,3,4-butanetetracarboxylic acid (BTCA).

In specific embodiments, if the hydrogen bond donor is according to a preferred embodiment in the form of a carboxylic acid, it is a tetracarboxylic acid, such as pyromellitic acid (1,2,4,5-benzenetetracarboxylic acid) or 1,2,3,4-butanetetracarboxylic acid (BTCA). Most preferred, the hydrogen bond donor is in the form of a carboxylic acid and is pyromellitic acid (1,2,4,5-benzenetetracarboxylic acid).

The amount of the anhydride-containing compound or the hydrogen bond donor selected from the group of alcohols, urea, and carboxylic acids, preferably the anhydride-containing compound or the hydrogen bond donor in the form of a carboxylic acid, which may be used for preparing the expandable microspheres of the present invention is not particularly limited.

However, the amount of the anhydride-containing compound or the hydrogen bond donor selected from the group of alcohols, urea, and carboxylic acids, preferably the anhydride-containing compound or the hydrogen bond donor in the form of a carboxylic acid, may be from 0.01 to 50 wt % based on the total weight of the anhydride-containing compound or the hydrogen bond donor, respectively, and the carboxylate-functionalised cellulose. In embodiments, it can be in the range of from 0.01 to 40 wt %, for example in the range of from 0.05 to 35 wt %, in the range of from 0.1 to 30 wt % or even in the range of from 0.5 to 25 wt %, such as in the range of from 0.5 to 20 wt %, from 1.0 to 20 wt %, or even from 1.2 to 17 wt % or from 1.5 to 15 wt %, the wt % being based on the total weight of the anhydride-containing compound or the hydrogen bond donor, respectively, and the carboxylate-functionalised cellulose.

In some embodiments, if the carboxylate-functionalised cellulose is an acetate-functionalised cellulose, the amount of the anhydride-containing compound or the hydrogen bond donor selected from the group of alcohols, urea, and carboxylic acids, preferably the anhydride-containing compound or the hydrogen bond donor in the form of a carboxylic acid, may be from 0.01 to 50 wt %, such as in the range of from 0.01 to 40 wt %, in the range from 0.05 to 30 wt %, in the range of from 0.1 to 20 wt % or even in the range of from 0.5 to 15 wt %, such as in the range of from 0.5 to 10 wt %, from 1.0 to 5.0 wt %, or even from 1.2 to 5 wt % or from 1.5 to 5 wt %, the wt % being based on the total weight of the anhydride-containing compound or the hydrogen bond donor, respectively, and the acetate-functionalised cellulose.

In some embodiments, if the carboxylate-functionalised cellulose is an butyrate-functionalised cellulose or a propionate-functionalised cellulose, such as preferably a cellulose acetate butyrate (CAB) or a cellulose acetate propionate (CAP), respectively, the amount of the anhydride-containing compound or the hydrogen bond donor selected from the group of alcohols, urea, and carboxylic acids, preferably the anhydride-containing compound or the hydrogen bond donor in the form of a carboxylic acid, may be from 0.01 to 50 wt %, such as in the range of from 0.01 to 40 wt %, in the range from 0.05 to 35 wt %, in the range of from 0.1 to 30 wt % or even in the range of from 0.5 to 25 wt %, such as in the range of from 1.0 to 20 wt %, from 3.0 to 20 wt %, or even from 5.0 to 18 wt % or from 10 to 15 wt %, the wt % being based on the total weight of the anhydride-containing compound or the hydrogen bond donor, respectively, and the butyrate-functionalised cellulose or propionate-functionalised cellulose, respectively.

In further embodiments, the polymeric shell can comprise particles to improve the mechanical properties and gas barrier of the polymer shell, thus also acting as polymer shell enhancers.

Examples of such particles are talc, montmorillonite, nanocrystalline cellulose and various types of clay, such as bentonite.

A number of factors can result in high densities. For example, high density can result from poor microsphere yield, i.e. the percentage of microspheres in the polymeric material is too low to reduce the overall density to an acceptable level. Another issue is poor expansion characteristics, which can arise where too many of the microspheres contain insufficient blowing agent to enable adequate expansion. This can result from the polymer shell being too permeable to the blowing agent, or due to the formation of so-called “multiple core” microspheres where, instead of a single blowing agent-containing core, there are multiple blowing agent-containing cores within the shell (e.g. like a microspherical foam or sponge). In such multi-core microspheres, the blowing agent concentration is typically too low to reduce the density adequately. Another cause is aggregation or agglomeration of the polymer, resulting in poor microsphere production and a denser material. Too high a proportion of aggregated material or poorly expanding microspheres can also lead to large inhomogeneity in the expansion characteristics of the resulting microsphere product. This is particularly unfavourable for surface-sensitive applications such as coatings, where a smooth finish is desirable.

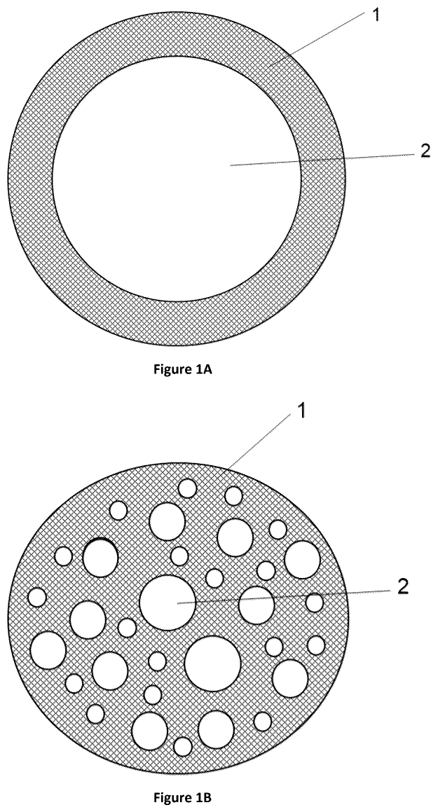

Illustrative cross sections of single core and multi-core microspheres are provided in FIGS. 1A and 1B respectively, where regions of polymer, 1, are represented by the cross-hatched areas, and blowing agent-containing regions, 2, are represented by blank areas.

The thermally expandable microspheres comprise at least one blowing agent. The one or more blowing agents generally have a boiling point above 25° C. at 5.0 bara pressure or above 25° C. at 3.0 bara pressure, where “bara” stands for bar-absolute. In embodiments, they have a boiling point above 25° C. at atmospheric pressure (1.013 bara). Typically, they have a boiling point of 250° C. or less at atmospheric pressure, for example 220° C. or less, or 200° C. or less. They are preferably inert, and do not react with the functionalised cellulose shell. Boiling points at elevated pressures can be calculated using the Clausius Clapeyron equation.

Examples of blowing agents include dialkyl ethers, alkanes and halocarbons, e.g. chlorocarbons, fluorocarbons or chlorofluorocarbons. In embodiments, the dialkyl ether comprises two alkyl groups each selected from C₂ to C₅ alkyl groups. In embodiments, the alkane is a C₄ to C₁₂ alkane. In embodiments, the haloalkane is selected from C₂ to C₁₀ haloalkanes. The haloalkanes can comprise one or more halogen atoms selected from chlorine and fluorine. The alkyl or haloalkyl groups in the dialkyl ethers, alkanes and haloalkanes can be linear, branched or cyclic. One or a mixture of one or more blowing agents can be used.

In embodiments, for environmental reasons, the one or more blowing agents are selected from alkyl ethers and alkanes, and in further embodiments the one or more blowing agents are selected from alkanes. Haloalkanes are preferably avoided, due to their potential ozone depletion properties, and also due to their generally higher global warming potential.

Examples of suitable blowing agents that can be used include n-pentane, isopentane, neopentane, cyclopentane, cyclohexane, n-butane, isobutane, isohexane, neohexane, heptane, isoheptane, octane, isooctane, isodecane, and isododecane. In preferred embodiments, the blowing agent is selected from C₄ to C₁₂ iso-alkanes.

In the expandable microspheres, the one or more blowing agents are typically present in an amount of from 5 to 50 wt %, based on the total weight of functionalised cellulose, blowing agent(s) and possible additive(s), such as an anhydride-containing compound or a hydrogen bond donor selected from the group of alcohols, urea, and carboxylic acids, for example in the range of from 5 to 45 wt %, or from 10 to 40 wt %.

Carboxylate-functionalised cellulose materials can be purchased commercially, or can be made by known means, for example through mixing cellulose with a suitable carboxylic acid (for instance acetic acid, propionic acid, or butyric acid and, optionally, additional carboxylic acids) in the presence of a strong acid such as sulfuric acid, or by base-catalysed reaction of cellulose with acyl chloride, for example as described in Nishio et al; Cellulose, 2006 (13), 245-259.

Examples of suitable carboxylate-functionalised celluloses are cellulose acetate (CA) (i.e. acetate-functionalized cellulose which does not comprise a further carboxylate functionality different from acetate), cellulose acetate propionate (CAP) and cellulose acetate butyrate (CAB), particularly cellulose acetate (CA), cellulose acetate propionate (CAP) and cellulose acetate butyrate (CAB) having a number average molecular weight (Mₙ) in the range of from 2,000 to 100,000 Da, such as in the range of 2,000 to 80,000 Da, in the range of 10,000 to 50,000 Da or in the range of 20,000 to 50,000 Da.

Preferred acetate-functionalised celluloses are cellulose acetates (CA) (i.e. acetate-functionalized cellulose which does not comprise a further carboxylate functionality different from acetate) and cellulose acetate butyrates (CAB) having a number average molecular weight (Mₙ) in the range of from 10,000 to 100,000 Da, such as within the range of 10,000 to 80,000 Da, preferably in the range of from 10.000 to 50,000 Da, and more preferably in the range of from 20,000 to 50,000 Da. Even more preferred are cellulose acetates (CA) having a number average molecular weight (Mₙ) in the range of from 10,000 to 100,000 Da, such as within the range of 10,000 to 80,000 Da, preferably in the range of from 10,000 to 50,000 Da, and more preferably in the range of from 20,000 to 50,000 Da.

For instance, if the polymeric shell comprises cellulose acetate propionate (CAP) or cellulose acetate butyrate (CAB), the amount of the hydrogen bond donor in the form of a carboxylic acid which is used may be from 0.01 to 50 wt % based on the total weight of the hydrogen bond donor and the carboxylate-functionalised cellulose. In embodiments, it can be in the range of from 0.01 to 40 wt %, for example in the range of from 0.05 to 35 wt %, in the range of from 0.1 to 30 wt % or even in the range of from 0.5 to 25 wt %, such as in the range of from 1.0 to 20 wt %, from 3.0 to 20 wt %, or even from 5.0 to 18 wt % or from 10 to 15 wt %, the wt % being based on the total weight of the hydrogen bond donor and the carboxylate-functionalised cellulose.

For instance, if the polymeric shell comprises cellulose acetate (CA) (i.e. acetate-functionalized cellulose which does not comprise a further carboxylate functionality different from acetate), the amount of the hydrogen bond donor in the form of a carboxylic acid which is used may be from 0.01 to 50 wt % based on the total weight of the hydrogen bond donor and the carboxylate-functionalised cellulose. In embodiments, it can be in the range of from 0.01 to 40 wt %, for example in the range of from 0.05 to 30 wt %, in the range of from 0.1 to 20 wt % or even in the range of from 0.5 to 15 wt %, such as in the range of from 0.5 to 10 wt %, from 1.0 to 5.0 wt %, or even from 1.2 to 5 wt % or from 1.5 to 5 wt %, the wt % being based on the total weight of the hydrogen bond donor and the carboxylate-functionalised cellulose.

The storage stable thermally expandable microspheres of the present invention retain at least 80% of the original weight of blowing agent encapsulated in the microspheres after six months of storage under ambient conditions.

Preferably, the storage stable thermally expandable microspheres of the present invention retain at least 85%, preferably at least 90%, even more preferably at least 95%, and most preferably at least 98%, of the original weight of blowing agent encapsulated in the microspheres after six months of storage under ambient conditions.

The determination of the weight of blowing agent in microspheres can be achieved by measuring the volatile content of the microspheres (i.e. the weight of volatiles encapsulated in the microspheres). Hence, the terms “weight of blowing agent” or “weight percentage of blowing agent” and “volatile content” as used herein in the context of microspheres are considered equivalent and are used interchangeably. The determination of the volatile content of microspheres is well-known by the skilled person and in principle any suitable method for determining the volatile content of microspheres can be used.

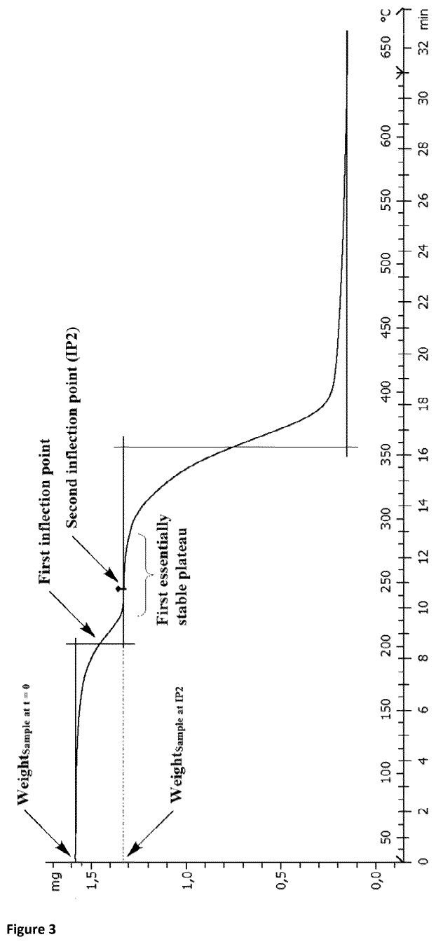

For instance, the volatile content can be determined using a Mettler Toledo TGA/DSC1 TGA-instrument. In an exemplified and preferred experimental setup, the volatile content of microspheres according to the present invention is determined as follows: The sample to be analyzed is prepared from 1.7 mg (+/−0.2 mg) of the thermally expandable microspheres contained in an aluminum oxide crucible with a volume of 600 μl. The temperature of the sample is increased from 30° C. to 650° C. under a nitrogen atmosphere with a heating rate of 20° C./min. The sample is kept at 650° C. under a nitrogen atmosphere for two more minutes, after which the nitrogen is replaced by air and the sample is kept at 650° C. for 15 more minutes. The weight of the sample is continuously monitored during the heating procedure. An exemplary thermogram thus obtained is shown in FIG. 3 with sample weight (in mg) on the ordinate and heating temperature (in ° C. which correlates to heating time (t) up to 650° C.) on the abscissa. The volatile content (VC, in %) of the microspheres can be obtained from such thermogram by subtracting the sample's weight measured at the second inflection point (IP2) of the thermogram curve (i.e. where the sample's weight reaches a first essentially stable plateau after evaporation of the blowing agent which is—depending on the actual blowing agent and polymer used—usually between 170° C. and 300° C.) from the sample's start weight (SW; at 30° C. and t=0) and dividing this difference by the sample's start weight and multiplying the result with 100 (see also the following Formula (2)).

$${VC}_{Sample} = ( ( We i g h {t}_{S a mple at t = 0} - W e i g h {t}_{S a mple at IP 2} ) / {Weight}_{Sample at t = 0} ) * 100 \qquad Formula ( 2 )$$

The percentage of blowing agent which is retained in a microsphere after storage (VC_{retained after storage}; in %) can be calculated by dividing the volatile content after storage (VC_{aafter storage}) by the volatile content before storage (VC₀) and multiplication with 100 (see also the following Formula (3)).

$${VC}_{r e t a ined after storage} = ( {VC}_{after storage} / {VC}_{0} ) * 100 \qquad Formula ( 3 )$$

The term “ambient conditions” as used herein means normal shelf storage conditions at standard room temperature within the range of 20-25° C., such as 22.5±2.5° C., or 22±2° C., or 22±1° C., and atmospheric pressure (i.e. 1013±50 mbar, such as 1013±20 mbar, or 1013±10 mbar).

The expandable microspheres of the present invention can be prepared according to the following method. Hence, in a further aspect, the present invention is directed to a method for preparing storage stable thermally expandable microspheres comprising a polymeric shell surrounding a hollow core, wherein the hollow core comprises a blowing agent, and the polymeric shell comprises a carboxylate-functionalised cellulose, i.e. expandable microspheres such as described above, wherein the method comprises the following steps:
(i) preparing thermally expandable microspheres comprising a polymeric shell surrounding a hollow core, wherein the hollow core comprises a blowing agent, and the polymeric shell comprises a carboxylate-functionalised cellulose; and
(ii) subjecting the thermally expandable microspheres obtained in step (i) to a post heating treatment by heating the thermally expandable microspheres to a temperature of at least 40° C.

As the method according to the further aspect of the present invention provides expandable microspheres as described above, i.e. microspheres retaining at least 80% of the original weight of blowing agent encapsulated in the microspheres after six months of storage under ambient conditions, all features concerning the polymeric shell of the expandable microspheres and the components used to prepare the same including the optional further components such as the anhydride-containing compound or the hydrogen bond donor selected from the group of alcohols, urea, and carboxylic acids, as well as the blowing agent and any further optional components may be the same as described above for the expandable microspheres according to the first aspect of the present invention.

In the first step (i) of the method according to the further aspect of the present invention thermally expandable microspheres comprising a polymeric shell surrounding a hollow core are prepared, wherein the hollow core comprises a blowing agent, and the polymeric shell comprises a carboxylate-functionalised cellulose.

In principle, any known method for preparing such expandable microspheres can be used. Suitable methods include for instance solvent extraction methods or, alternatively, spray drying methods, preferably spray drying methods.

Solvent extraction methods can be used to prepare expandable microspheres by dissolving the components including the optional anhydride-containing compound or hydrogen bond donor selected from the group of alcohols, urea, and carboxylic acids in a suitable organic solvent or mixture of solvents, adding the one or more blowing agents, and mixing with an aqueous phase that optionally comprises one or more emulsifiers. After a period of time (e.g. for 1 minute to 20 hours, such as in the range of from 5 minutes to 10 hours), optionally under active mixing, e.g. by stirring, the unexpanded microspheres form, and can be separated as a solid, for example using conventional techniques such as decantation or filtration.

Mixing can be carried out at ambient temperature, although temperatures in the range of from 5 to 75° C. can be used.

In embodiments, the aqueous phase can be pre-saturated with one or more organic solvents in which the carboxylate-functionalised cellulose is soluble, before being mixed with the carboxylate-functionalised cellulose-containing organic phase. In further embodiments, the mixture can be left or stirred for a period of time, for example from 1 to 100 hours, or from 2 to 50 hours, to allow evaporation of at least part of the solvent/water mixture. This can be at temperatures in the range of from 10 to 95° C., for example at a temperature of from 20 to 90° C.

The emulsifier helps to stabilise droplets of the carboxylate-functionalised cellulose-containing organic phase in the aqueous phase, and in embodiments assists in the formation of an emulsion of the organic phase in the aqueous phase (i.e. an oil-in-water type emulsion).

The stabilisation of the droplets or emulsion droplets is preferred for a number of reasons. Without stabilisation, coalescence of the droplets containing the carboxylate-modified cellulose and the blowing agents may occur. Coalescence can have negative effects; such as non-uniform droplet size, poor yields of microspheres, and can also increase aggregation of the microspheres.

The emulsifier is typically present in an amount of 0 to 20 wt %, for example from 0.01 to 20 wt %, from 0.05 to 10 wt %, of from 0.1 to 5 wt % in the aqueous phase. In further embodiments, the emulsifier is present in an amount of from 0.1 to 1 wt % in the aqueous phase.

The choice of emulsifier is not particularly limited, and can be chosen from inorganic or organic emulsifiers.

Examples of inorganic materials that can act as an emulsifier include silica, in particular colloidal silica, that can either be used in an unmodified “bare” form, or optionally can be surface modified to tailor its hydrophobic/hydrophilic characteristics, for example using organosilane-modified silica or colloidal silica.

In embodiments, an “organo” group in the organosilane can be selected from C₁₋₂₀ alkyl, C₁₋₂₀ alkenyl, C₅₋₆ aryl, and C₅₋₆ heteroaryl with one or more (e.g. 1 to 3) heteroatoms selected from O, S and N. Each of these groups can optionally be substituted with one or more groups selected from halide, hydroxy, epoxy, thiol, amino, C₁₋₂₀ alkylamino, di-C₁₋₂₀ alkylamino, hydroxyamino, hydroxy-C₁₋₂₀ alkylamino, (hydroxy-C₁₋₂₀ alky)(C₁₋₂₀ alkyl)amino, di(hydroxy-C₁₋₂₀ alkyl)amino C₁₋₂₀ alkoxy, C₁₋₂₀ amido, C₁₋₂₀ ureido, C₁₋₂₀ mercapto, C₃₋₂₀ epoxyalkoxy, C₁₋₂₀ alkylacrylate, ethylene glycol or oligomers thereof with 1 to 20 ethylene glycol groups, and propylene glycol or oligomers thereof with 1 to 20 propylene glycol groups. Any aliphatic groups can be linear, branched or cyclic.

The organosilane modified silica or colloidal silica can be produced by reacting silica (or colloidal silica) with an organosilane compound, typically having the formula RₙSiX₄₋ₙ, where R is one of the above-identified organic groups, X is a halide, hydroxy or C₁₋₆ alkoxy, and n is an integer in the range of from 1 to 3, typically 1 or 2.

Suitable silane compounds include tris-(trirnethoxy)silane, octyl triethoxysilane, methyl triethoxysilane, methyl trimethoxysilane; gamma-mercaptopropyl trimethoxysilane, beta-(3,4-epoxycyclohexyl)-ethyl trimethoxysilane; silanes containing an epoxy group (epoxy silane), glycidoxy and/or a glycidoxypropyl group such as gamma-glycidoxypropyl trimethoxysilane, gamma-glycidoxypropyl methyldiethoxysilane, (3-glycidoxypropyl)trimethoxy silane, (3-glycidoxypropyl) hexyltrimethoxy silane, beta-(3,4-epoxycyclohexyl)-ethyltriethoxysilane; silanes containing a vinyl group such as vinyl triethoxysilane, vinyl trimethoxysilane, vinyl tris-(2-methoxyethoxy)silane, vinyl methyldimethoxysilane, vinyl triisopropoxysilane; gamma-methacryloxypropyl trimethoxysilane, gamma-methacryloxypropyl triisopropoxysilane, gamma-methacryloxypropyl triethoxysilane, octyltrimethyloxy silane, ethyltrimethoxy silane, propyltriethoxy silane, phenyltrimethoxy silane, 3-mercaptopropyltriethoxy silane, cyclohexyltrimethoxy silane, cyclohexyltriethoxy silane, dimethyldi ethyoxy silane, 3-chloropropyltriethoxy silane, 3-methacryoxypropyltrimethoxy silane, i-butyltriethoxy silane, trimethylethoxy silane, phenyldimethylethoxy silane, hexamethyldisiloxane, trimethylsilyl chloride, vinyltriethoxy silane, hexamethyldisilizane, and mixtures thereof. U.S. Pat. No. 4,927,749 discloses further suitable silanes which may be used.

Examples of silica that can be used include those sold under the Levasil™, Bindzil™ and Ludox™ trade names, which are associated with colloidal silica. Solid forms of silica include fumed silica and precipitated silica can also be used, which can be dispersed in water to form a fine suspension. Sources of fumed silica include those sold under the trade names Cab-o-Sil™ and Aerosil™.

Other inorganic emulsifiers include colloidal clays (e.g. chalk and bentonite), and salts, oxides and hydroxides of Al, Ca, Mg, Ba, Fe, Zn, Ti, Ni and Mn (e.g. calcium phosphate, calcium carbonate, magnesium hydroxide, barium sulphate, calcium oxalate, titanium dioxide, and hydroxides of aluminium, iron, zinc, nickel or manganese).

When solid, inorganic emulsifiers are used, they can produce so-called “Pickering” emulsions, where the solid inorganic particles are at the interface between the aqueous and organic phases.

Organic emulsifiers include anionic, cationic, amphoteric, zwitterionic and nonionic surfactants, which are generally known and available commercially.

Examples include sorbitan esters (such as those sold under the trade name Span™), e.g. sorbitan monolaurate (e.g. Span™ 20) and sorbitan monooleate (e.g. Span™ 80). Further examples include polyethoxylated sorbitan esters (e.g. those sold under the trade name Tween™), such as PEG-20 sorbitan monolaurate (Tween™ 20), PEG-20 sorbitan monooleate (Tween™ 80) and Polyoxyethylenesorbitan trioleate (Tween™ 85). Other examples include C₆-C₂₂ alkyl sulfates, such as sodium dodecyl sulfate; sulfates with anions of formula CₙH₂ₙ₊₁(OCₘH₂ₘ)ₚ—OSO₃⁻ where n is from 6 to 22, m is from 2 to 3, and p is from 2 to 4, such as sodium lauryl ether sulfate and sodium C₁₂₋₁₄ pareth-3 sulfate; C₆₋₂₂ alkyl glycosides, such as lauryl glucoside; glucamides of formula CₙH₂ₙ₊₁(O)N(X)CH₂(C₄H₄[OH]₄)CH₂OH, where n is from 6 to 22, and X is H or C₁₋₄ alkyl, for example capryl methyl glucamide, lauryl methyl glucamide and dodecyl glucamide; amino acids substituted with C₂₋₁₆ carboxylate groups and their salts, for example sodium or disodium cocoyl glutamate and sodium lauroyl sarcosinate; C₆₋₂₂ fatty acids and their salts, such as sodium oleate and potassium oleate; polyethylene glycol-substituted phenols with 5 to 25 glycol units, for example polyethylene glycol p-(1,1,3,3-tetramethylbutyl)-phenyl ether (which is available as Triton™ X-100); C₆₋₂₂ alkyl amine oxides, such as lauramine oxide and C₆₋₂₂ alkyl alcohols, such as cetyl alcohol and stearyl alcohol. Further examples include polymeric emulsifiers, such as (meth)acrylate and (meth)acrylic acid polymers (e.g. polymethylmethacrylic acid) and polymers based on organoammonium salts having at least one C₃₋₁₀ alkenyl group and at least one C₁₋₄ alkyl group, for example polydiallyldimethylammonium chloride (polyDADMAC).

Consumer washing-up liquids can be used as the source of the emulsifier, for example those sold under the trade names Yes® and Fairy®, which comprise sodium dodecyl sulfate, sodium C₁₂₋₁₄ pareth-3-sulfate and lauramine oxide.

Other examples of emulsifiers include polyvinyl alcohols, optionally partially or fully saponified. In embodiments, the polyvinyl alcohol has a degree of hydrolysis in the range of from 70 to 100 mol %, for example in the range of from 80 to 100 mol %, or from 80 to 98 mol %. The Hoppler viscosity in 4% aqueous solution can be 1 to 70 mPas, or in other embodiments in the range of from 3 to 40 mPas (measured at 20° C. according to DIN 53015).

One or more emulsifiers can be used. Mixtures of organic and inorganic emulsifiers can also be used.

The organic solvent can be selected from those having one or more functional group selected from esters, amides, aldehydes, ketones, alcohols (including glycols) and ethers, for example those having 3 to 12 carbon atoms. Esters, ketones and ethers may, in embodiments, be part of a cyclic structure. Further examples include haloalkanes having from 1 to 6 carbon atoms and halo-carboxylic acids having from 1 to 6 carbon atoms, where the halogen is selected from fluorine, chlorine, bromine and iodine. In embodiments, any alcohols used are glycols.

Examples of organic solvents that can be used include ethyl acetate, ethyl formate, methyl acetate, n-propyl formate, iso-propyl formate, n-propyl acetate, iso-propyl acetate, iso-butyl acetate, n-butyl acetate, n-pentyl formate, iso-pentyl formate, n-pentyl acetate, iso-pentyl acetate, ethyl propionate, iso-butyl iso-butyrate, n-butyl propionate, ethyl 3-ethoxypropionate, 2-ethylhexyl acetate, acetone, methyl ethyl ketone, diethyl ketone, methyl isobutyl ketone, methyl isoamyl ketone, methyl n-amyl ketone, mesityl oxide, acetophenone, cyclohexanone, diethyl phthalate, ethyl lactate, benzyl acetate, butyrolactone, acetyl acetone, methyl cyclohexanone, benzaldehyde, diisobutyl ketone diacetone alcohol, ethylene glycol, glyceryl-α-monochlorohydrin, propylene glycol, glycol ethers (for example propylene glycol monomethyl ether, ethylene glycol mono-methyl ether, ethylene glycol mono-ethyl ether, ethylene glycol mono-n-butyl ether, propylene glycol mono-tert-butyl ether, propylene glycol monopropyl ether, propylene glycol monobutyl ether), glycol ether esters (for example ethylene glycol mono-methyl ether acetate, ethylene glycol mono-ethyl ether acetate, ethylene glycol mono-butyl ether acetate, ethylene glycol diacetate), n-propyl alcohol, iso-propyl alcohol, n-butanol, sec-butanol, isobutanol, benzyl alcohol, diisopropyl ether, dimethoxymethane, dimethoxyethane, 1,4-dioxane, 1,3-dioxolane, tetrahydrofuran, anisole, phenetole and dimethyl formamide. Other examples of solvents include dimethyl sulfoxide, toluene, xylene, n-methyl-2-pyrrolidone, methyl chloride, chloroform, carbon tetrachloride, trichloroacetic acid, methyl bromide, methyl iodide, trichloroethylene, and tetrachloroethylene. The organic solvent can be a mixture of two or more solvents. The organic solvent can comprise water, although typically the water content of the organic solvent(s) before mixing with the aqueous phase is less than 5 wt %, i.e. 0 to 5 wt % water, for example 0 to 1 wt % water.

In embodiments, the solvent is selected from one or more of ethyl acetate, methyl acetate, ethyl formate and acetone.

Typically, the carboxylate-functionalised cellulose content of the organic phase is in the range of from 0.1 to 50 wt %. In embodiments, it can be in the range of from 0.5 to 25 wt %, for example in the range of from 1 to 15 wt %.

The amount of blowing agent(s) in the organic phase is typically in the range of from 0.5 to 20 wt %, for example in the range of from 1 to 15 wt %. In embodiments, the weight of blowing agent in the organic phase is equal to or less than the weight of carboxylate-functionalised cellulose, for example the weight ratio of blowing agent to carboxylate-functionalised cellulose can be 1.0 or less, for example 0.8 or less. In embodiments the minimum weight ratio is 0.1, or in further embodiments 0.2. In embodiments, the weight ratio of blowing agent to carboxylate-functionalised cellulose in the organic phase is in the range of from 0.1 to 1.0, such as in the range of from 0.2 to 0.8.

The weight percentage of the organic phase in the total water/organic phase emulsion can be in the range of from 0.1 to 45 wt %, for example in the range of from 1 to 30 wt % or from 3 to 25 wt %, or from 4 to 15 wt % based on the total weight of the water/organic phase emulsion.

If substances that react with groups on the carboxylate-functionalised celluloses and/or particles are added to further improve the polymeric shell properties, typically, these substances and/or particles are added to the organic phase (i.e. the phase containing carboxylate-functionalised cellulose, solvent and blowing agent).

Alternatively, and preferably, the expandable microspheres are prepared by a spray drying process comprising mixing the carboxylate-functionalised cellulose, an organic solvent, the blowing agent and, optionally, the anhydride-containing compound or the hydrogen bond donor selected from the group of alcohols, urea, and carboxylic acids, and then spraying the thus obtained mixture into a drying equipment to produce the thermally expandable microspheres having a polymeric shell surrounding a hollow core, in which the polymeric shell comprises the carboxylate-functionalised cellulose, and the hollow core comprises the blowing agent.

In principle, the spray drying equipment for performing the spray drying process is not limited and any conventional and commercially available spray drying equipment can be used for the spray drying process. A typical spray drying equipment suitable for the process described herein comprises a drying chamber equipped with a nozzle, an inlet for drying gas and an outlet which connects the drying chamber with a cyclone. Through the nozzle which is normally located at the top of the spraying chamber (but may be also located on any other portion of the spray dryer) the liquid to be atomized is sprayed, usually in combination with a spray gas, into the drying chamber. In the drying chamber, the atomized liquid is dried by the drying gas which is fed into the spraying chamber through the inlet for drying gas. The inlet of drying gas may for instance be located besides the nozzle. The atomized liquid dries and forms particles. The thus obtained particles are then fed together with the drying gas through the outlet of the drying chamber which is normally located in the bottom area of the drying chamber into a cyclone. In the cyclone the particles are separated from the drying air. The drying air may be further filtered to remove any residual particles from the drying air.

A suitable spray drying equipment for performing the spray drying process is the Büchi mini spray dryer B-290 which is commercially available from Büchi/Switzerland.

The order of adding the carboxylate-functionalised cellulose, the organic solvent, the blowing agent and, optionally, the anhydride-containing compound or the hydrogen bond donor selected from the group of alcohols, urea, and carboxylic acids for mixing is not restricted and any order can be chosen.

However, in a preferred embodiment, in the process for producing the expandable microspheres, the carboxylate-functionalised cellulose is mixed first with the organic solvent, and then, in a further step the blowing agent and, optionally, the anhydride-containing compound or the hydrogen bond donor selected from the group of alcohols, urea, and carboxylic acids is added to the mixture.

The mixing of the carboxylate-functionalised cellulose can be carried out at ambient temperature, although temperatures in the range of from 5 to 75° C. can be used. Mixing is usually performed till the carboxylate-functionalised cellulose has completely dissolved in the organic solvent.

In embodiments, the mixture of the carboxylate-functionalised cellulose with the organic solvent can be left or stirred for a period of time, for example from 1 to 100 hours, or from 2 to 50 hours, to allow evaporation of at least part of the solvent. This can be at temperatures in the range of from 10 to 95° C., for example at a temperature of from 20 to 90° C.

In a further step, the blowing agent and, optionally, the anhydride-containing compound or the hydrogen bond donor selected from the group of alcohols, urea, and carboxylic acids are added to the mixture of carboxylate-functionalised cellulose and organic solvent. In case an anhydride-containing compound or an hydrogen bond donor selected from the group of alcohols, urea, and carboxylic acids is added to the mixture of carboxylate-functionalised cellulose and organic solvent, the order of adding the blowing agent and the anhydride-containing compound or the hydrogen bond donor selected from the group of alcohols, urea, and carboxylic acids is not critical and, thus, the blowing agent may be added first, followed by the addition of the anhydride-containing compound or the hydrogen bond donor selected from the group of alcohols, urea, and carboxylic acids or, alternatively, the anhydride-containing compound or the hydrogen bond donor selected from the group of alcohols, urea, and carboxylic acids may be added first, followed by the addition of the blowing agent. Also this mixing step can be carried out at ambient temperature, although temperatures in the range of from 5 to 75° C. can be used. Also this mixing step is usually performed till the blowing agent and, optionally, the anhydride-containing compound or the hydrogen bond donor selected from the group of alcohols, urea, and carboxylic acids has completely dissolved in the organic solvent.

After the addition of the blowing agent and, optionally, the anhydride-containing compound or the hydrogen bond donor selected from the group of alcohols, urea, and carboxylic acids, to the mixture of carboxylate-functionalised cellulose and organic solvent, the thus obtained mixture may be further stirred for a period of time, for example from 1 minute to 100 hours, such as from 10 minutes to 80 hours or from 1 to 50 hours. Also this can be at temperatures in the range of from 10 to 95° C., for example at a temperature of from 20 to 90° C.

The mixture comprising the carboxylate-functionalised cellulose, the organic solvent, the blowing agent and, optionally, the anhydride-containing compound or the hydrogen bond donor selected from the group of alcohols, urea, and carboxylic acids is then sprayed into a drying equipment to produce the thermally expandable microspheres as described herein. The drying equipment may be a spray drying equipment as described above.

The optional spray gas that is sprayed through the nozzle together with the liquid to be atomized is not particularly limited and may be any suitable spray gas known by the skilled person. For instance, the spray gas may be selected from nitrogen, carbon dioxide, (pressurized) air, noble gases, such as argon, etc. Preferably, in the method for producing expandable microspheres as described herein a spray gas is used and more preferably this spray gas is nitrogen.

Also the drying gas is not particularly limited and may be any suitable drying gas known by the skilled person. For instance, also the spray gas may be selected from nitrogen, carbon dioxide, (pressurized) air, noble gases, such as argon, etc. Preferably, the drying gas is nitrogen.

Further process parameters for running the spray drying equipment, such as the spray gas flow, the inlet temperature of the drying gas when entering the drying chamber, the feed rate of the liquid to be atomized and the aspirator speed to circulate the drying gas in the spray drying equipment can be readily chosen by the skilled person.

It has been found that with the above-described method it is possible to obtain expandable microspheres comprising a polymeric shell surrounding a hollow core, wherein the hollow core comprises a blowing agent, and the polymeric shell comprises a carboxylate-functionalised cellulose. It has been further found that this method is particularly suitable to obtain such expandable microspheres, wherein the polymeric shell further comprises an anhydride-containing compound or a hydrogen bond donor selected from the group of alcohols, urea, and carboxylic acids.

The organic solvent can be selected from the same solvents as described above in the context of the solvent extraction method for preparing expandable microspheres.

Typically, the carboxylate-functionalised cellulose content in the mixture for spray drying is typically in the range of from 0.1 to 50 wt %. In embodiments, it can be in the range of from 1 to 40 wt %, for example in the range of from 5 to 35 wt % or even from 7.5 to 30 wt %. The wt % are based on the total weight of the mixture for spray drying.

The amount of blowing agent(s) in the mixture for spray drying is typically in the range of from 0.5 to 50 wt %. In embodiments, it can be in the range of from 0.5 to 40 wt %, for example in the range of from 1 to 30 wt % or even from 3 to 25 wt %. In embodiments, the weight of blowing agent in the mixture for spray drying is equal to or less than the weight of carboxylate-functionalised cellulose, for example the weight ratio of blowing agent to carboxylate-functionalised cellulose can be 1.5 or less, for example 1.3 or less or even 1.1 or less. In embodiments the minimum weight ratio is 0.1, or in further embodiments 0.2. In embodiments, the weight ratio of blowing agent to carboxylate-functionalised cellulose in the organic phase is in the range of from 0.1 to 1.5, such as in the range of from 0.2 to 1.3 or even from 0.3 to 1.1.

The amount of anhydride-containing compound or a hydrogen bond donor selected from the group of alcohols, urea, and carboxylic acids in the mixture for spray drying is typically in the range of from 0 to 15 wt %. In embodiments, it can be in the range of from 0.01 to 15 wt %, for example in the range of from 0.05 to 10 wt %, in the range of from 0.1 to 5 wt % or even in the range of from 0.2 to 5 wt %. The wt % are based on the total weight of the mixture for spray drying.

The amount of the organic solvent adds up to 100 wt %. Preferably, the amount of organic solvent is at least 30 wt %, more preferably at least 40 wt % and even more preferably at least 50 wt %. The wt % are based on the total weight of the mixture for spray drying.

The unexpanded microspheres obtained by either the solvent extraction method or the spray drying method typically have volume mean particle sizes (diameters), i.e. D(0.5) values, in the range of from 1 to 500 μm, such as 5 to 200 μm or, in embodiments, from 10 to 100 μm or even from 30 to 80 μm.

In the second step (ii) of the method according to the further aspect of the present invention thermally expandable microspheres obtained in step (i) are subjected to a post heating treatment by heating the thermally expandable microspheres to a temperature of at least 40° C.

Surprisingly, it has been found that expandable microspheres which are post heating treated according to the second step (ii) of the method according to the further aspect of the present invention have a significantly improved storage stability, i.e. such post heating treated expandable microspheres retain at least 80%, such as at least 85%, at least 90%, at least 95%, and even at least 98%, of the original weight of blowing agent encapsulated in the microspheres after six months of storage under ambient conditions.

The heating can be performed by any known method for heating substances, such as for instance placing the expandable microspheres in a heat chamber or drying oven set to the appropriate temperature. The heating can also be performed by tumbling the material in a stirred vessel where the heating is achieved with either an inflow of heated gas to the vessel or through heating the walls of a jacketed vessel. Tumbling can be achieved by any means such as a ribbon blender set-up or by stirring with rotating paddles.

There is no particular upper limit for the temperature used for the post heating treatment.

However, any such temperature must be lower than the expansion temperature of the respective expandable microspheres as they otherwise will already start to expand. Hence, in embodiments, the post heating treatment may be performed at a temperature of between 50° C. and 150° C., preferably between 60° C. and 140° C., even more preferably between 70° C. to 130° C., and most preferably between 75° C. and 125° C.

There is no particular time length required for the post heating treatment. However, in some embodiments, the post heating treatment is performed for at least 5 minutes, preferably for at least 10 minutes, more preferably for at least 30 minutes, and even more preferably for at least 50 minutes. In embodiments, the post heating treatment is performed for not more than 10 hours, such as for not more than 5 hours, not more than 2 hours, or not more than 1 hour.

However, the temperature used for the post heating treatment and the time length of the post heating treatment might depend on each other, and the skilled person is able to adjust an appropriate time length of the post heating treatment for a particular treatment temperature and vice versa. For instance, a preferred method according to the further aspect of the present invention involves heating the expandable microspheres obtained in step (i) for 5 minutes to 2 hours, such as from 10 minutes to 1 hour, for instance for 1 hour, at 75° C. to 125° C., such as at 100° C.

The present invention is also directed to storage stable expandable microspheres obtained by the method including a post heating treatment as described above.

### EXAMPLES

The following examples are intended to illustrate the invention.

The volatile content in the microspheres was determined using a Mettler Toledo TGA/DSC1 TGA-instrument using the following procedure: The sample to be analysed was prepared from 1.7 mg (+/−0.2 mg) of the thermally expandable microspheres contained in an aluminum oxide crucible with a volume of 600 μl. The temperature of the sample was increased from 30° C. to 650° C. under a nitrogen atmosphere with a heating rate of 20° C./min. The sample was kept at 650° C. under a nitrogen atmosphere for two more minutes, after which the nitrogen was replaced by air and the sample was kept at 650° C. for 15 more minutes. The weight of the sample was continuously monitored during the heating procedure so to obtain a thermogram with sample weight (in mg) on the ordinate and heating temperature (in ° C. which correlates to heating time (t) up to 650° C.) on the abscissa. The volatile content (VC, in %) of the microspheres was obtained from such thermogram by subtracting the sample's weight measured at the second inflection point (IP2) of the thermogram curve (i.e. where the sample's weight has reached a first essentially stable plateau after evaporation of the blowing agent which was—depending on the actual blowing agent and polymer used—between 170° C. and 300° C.) from the sample's start weight (SW; at 30° C. and t=0) and dividing this difference by the sample's start weight and multiplying the result with 100 (see also Formula (2) as defined above). The percentage of blowing agent which is retained in a microsphere after storage (VC_{retained after storage}; in %) was calculated by dividing the volatile content after storage (VC_{after storage}) by the volatile content before storage (VC₀) and multiplication with 100 (see also Formula (3) as defined above).

The expansion characteristics were evaluated using a Mettler TMA/SDTA 841e thermomechanical analyser, interfaced with a PC running STARe software. The sample to be analysed was prepared from 0.5 mg (+/−0.02 mg) of the thermally expandable microspheres contained in an aluminum oxide crucible with a diameter of 6.8 mm and a depth of 4.0 mm. The crucible was sealed using an aluminum oxide lid with a diameter of 6.1 mm. Using a TMA Expansion Probe type, the temperature of the sample was increased from about 30° C. to 240° C. with a heating rate of 20° C./min while applying a load (net.) of 0.06 N with the probe. The displacement of the probe vertically was measured to analyze the expansion characteristics. Initial temperature of expansion (Tₛₜₐᵣₜ): the temperature (° C.) when displacement of the probe is initiated. The maximum temperature of expansion (Tₘₐₓ) is the temperature (° C.) when displacement of the probe reaches its maximum. The TMA density is the sample weight (d) divided by volume increase of the sample (dm³) when displacement of the probe reaches its maximum.

### General Synthesis Method:

A solution of carboxylate-functionalised cellulose polymer in a suitable organic solvent was prepared by dissolving the polymer overnight with the use of a magnetic stirrer.

Blowing agent was added to the solution, and the mixture was stirred for five minutes to re-dissolve any precipitated polymer.

If applicable, the anhydride-containing compound or the hydrogen bond donor selected from the group of alcohols, urea, and carboxylic acids was further added to the solution and the mixture was further stirred for ten minutes to dissolve the anhydride-containing compound or the hydrogen bond donor selected from the group of alcohols, urea, and carboxylic acids.

The thus obtained mixture was then sprayed-dried using a Büchi Mini Spray Dryer B-290. Nitrogen was used as spray gas with a feed rate of 238 l/h for the examples containing cellulose acetate butyrate (CAB), and with a feed rate of 307 l/h for the examples containing cellulose acetate (CA). The feed rate of the mixture to be spray dried was 13 ml/min. The temperature of the drying gas was at the inlet was 105° C. (for all examples using cellulose acetate 1 (CA1)) or 70° C. (for all examples using cellulose acetate butyrate 1 (CAB1)) and the aspirator rate was 38 m³/h.

Dried solids were collected from the bottom of the cyclone, analysed and if appliable subjected to further post-heating treatment.

Table 1 lists the carboxylate-functionalised cellulose polymers that were used to prepare microspheres. They were either cellulose acetate (CA) or cellulose acetate butyrate (CAB).

TABLE 1
Carboxylate-functionalised cellulose details

| | | Hydroxyl | Acetate | Butyrate | Total | Molecular | T_{g}/ | Tₘ/ |
|---|---|---|---|---|---|---|---|---|
| Polymer | | Content/wt % | Content/wt % | Content/wt % | DS | Weight | ° C. | ° C. |
| Reference | Source | (DS) | (DS) | (DS) | (1) | (2) | (3) | (4) |
| CA1 | Eastman | 3.5 (0.55) | 39.8 (2.45) | | 3.0 | 30 000 | 180 | 230-250 |
| CAB1 | Eastman | (0.19) | (2.03) | (0.76) | 2.98 | — | — | — |

(1) DS = Degree of substitution. Total DS = sum of DS of individual substituents
(2) Number Average Molecular Weight, as provided by supplier
(3) Glass transition temperature as provided by supplier (Eastman)
(4) Melting Point, as provided by supplier
— not specified/measured

### Example 1

The influence of a post heating treatment of 125° C. for 1 hour on expandable microspheres made from CA1 was determined.

A mixture containing 13.5 g CA1, 159.0 g acetone and 7.2 g isooctane was prepared and spray dried as described above to prepare expandable microspheres. T_{Start}, T_{Max}, TMA-density, as well as the volatile content of the obtained expandable microspheres were determined and are shown in Table 2.

TABLE 2
Microsphere properties

| | Anhydride- | | | | |
|---|---|---|---|---|---|
| | containing | Volatile | | | |
| | compound/ | content | | | TMA- |
| | hydrogen | (wt %) | | | density/g |
| Experiment | bond donor | (1) | Tₛₜₐᵣₜ/° C. | Tₘₐₓ/° C. | dm⁻³ |
| 1 | — | 13.6 | 176.4 | 219.6 | 20.9 |

(1) Volatile content of the microspheres, measured by TGA; based on the total weight of the microspheres
— not added

A charge of the obtained microspheres was divided into two portions of same size. One portion was subjected to a post heating treatment of 125° C. for 1 hour by placing approximately 1 g thereof in an oven set at 125° C. and the other portion was not subjected to a post heating treatment but just left as it was. Both portions of the expandable microspheres were then stored at 22.5±2.5° C. and standard pressure (1013±50 mbar), and the volatile content of the expandable microspheres was determined after 1 month, 2 months, and 6 months. In addition, the volatile content of the post heating treated expandable microspheres was also determined directly after the post heating treatment. The results are shown in Table 3.

TABLE 3
Volatile content of expandable microspheres after storage

| | | Volatile | Volatile | Volatile | Volatile | |
|---|---|---|---|---|---|---|
| Expandable | | content | content | content | content | |
| microspheres | Post | (wt %) | (wt %) | (wt %) | (wt %) | Percentual |
| from | heating | before | after 1 | after 2 | after 6 | retention |
| Experiment | treatment | storage | month | months | months | [%] |
| No. | (yes/no) | (1) | storage | storage | storage | (2) |
| 1 | yes | 11.3 | 11.3 | 11.2 | 11.0 | 97.3 |
| 1 | no | 13.6 | 7.7 | 5.9 | 3.1 | 22.8 |

(1) For the post heating treated expandable microspheres, this value indicates the volatile content after the post heating treatment; for the non-post heating treated expandable microspheres, this value indicates the volatile content after preparation of the microspheres.
(2) The percentual retention indicates how much volatile content after 6 months is retained compared to the volatile content before storage.

As can be seen from Table 3, the post heating treatment significantly improves the volatile content of the expandable microspheres. With the post heating treatment, a retention of volatiles of 97.3 wt % can be achieved even after storage for 6 months whereas the same untreated expandable microspheres have only a remaining volatile content of 22.8 wt %.

### Example 2

The influence of a post heating treatment of 100° C. for 1 hour on expandable microspheres made from CAB1 with 1,2,4,5-benzenetetracarboxylic dianhydride (pyromellitic dianhydride; PMDA) or 1,2,4,5-benzenetetracarboxylic acid (pyromellitic acid; PMA) was determined.

Mixtures containing CAB1, acetone, isooctane and PMA or PMDA in the amounts as specified in Table 4 were prepared and spray dried as described above to prepare expandable microspheres. T_{Start}, T_{Max}, TMA-density, as well as the volatile content of the obtained expandable microspheres were determined and are shown in Table 5.

TABLE 4
Components and amounts for preparing expandable microspheres

| | | Amount of | | | |
|---|---|---|---|---|---|
| | | Anhydride- | | | |
| | Anhydride- | containing | | | |
| | containing | compound/ | Amount | Amount | Amount |
| | compound/ | hydrogen | of | of | of |
| | hydrogen | bond donor | CAB1 | acetone | isooctane |
| Experiment | bond donor | [g] | [g] | [g] | [g] |
| 2 | PMDA | 0.57 | 6.0 | 40.0 | 4.0 |
| 3 | PMA | 0.67 | 6.0 | 40.0 | 4.0 |

TABLE 5
Microsphere properties

| | Anhydride- | | | | |
|---|---|---|---|---|---|
| | containing | Volatile | | | |
| | compound/ | content | | | TMA- |
| | hydrogen | (wt %) | | | density/g |
| Experiment | bond donor | (1) | Tₛₜₐᵣₜ/° C. | Tₘₐₓ/° C. | dm⁻³ |
| 2 | PMDA | 18.8 | 133.3 | 165.7 | 30.6 |
| 3 | PMA | 21.1 | 137.9 | 162.8 | 23.7 |

(1) Volatile content of the microspheres, measured by TGA; based on the total weight of the microspheres.

A charge of each of the obtained microspheres was divided into two portions of same size. For each experiment, one portion was subjected to a post heating treatment of 100° C. for 1 hour by placing approximately 1 g thereof in an oven set at 100° C. and the other portion was not subjected to a post heating treatment but just left as it was. All portions of the expandable microspheres were then stored at 22.5±2.5° C. and standard pressure (1013±50 mbar), and the volatile content of the expandable microspheres was determined after 1 month, 3 months, and 6 months. In addition, the volatile content of the post heating treated expandable microspheres was also determined directly after the post heating treatment. The results are shown in Table 6.

TABLE 6
Volatile content of expandable microspheres after storage

| | | Volatile | Volatile | Volatile | Volatile | |
|---|---|---|---|---|---|---|
| Expandable | | content | content | content | content | |
| microspheres | Post | (wt %) | (wt %) | (wt %) | (wt %) | Percentual |
| from | heating | before | after 1 | after 3 | after 6 | retention |
| Experiment | treatment | storage | month | months | months | [%] |
| No. | (yes/no) | (1) | storage | storage | storage | (2) |
| 2 | yes | 13.8 | 13.8 | 13.8 | 12.9 | 93.5 |
| 2 | no | 18.8 | 16.8 | 16.1 | 14.0 | 74.5 |
| 3 | yes | 18.6 | 18.8 | 18.3 | 16.2 | 87.1 |
| 3 | no | 21.1 | 18.6 | 17.0 | 14.7 | 69.7 |

(1) For the post heating treated expandable microspheres, this value indicates the volatile content after the post heating treatment; for the non-post heating treated expandable microspheres, this value indicates the volatile content after preparation of the microspheres.
(2) The percentual retention indicates how much volatile content after 6 months is retained compared to the volatile content before storage.

As can be seen from Table 6, the post heating treatment significantly improves the volatile content of the expandable microspheres. With the post heating treatment, a retention of volatiles of up to 93.5 wt % can be achieved even after storage for 6 months whereas the same untreated expandable microspheres have only a remaining volatile content of significantly less than 80 wt %.

### Example 3

The influence of different temperatures for the post heating treatment was determined using expandable microspheres prepared from CA1 with 1,2,4,5-benzenetetracarboxylic dianhydride (pyromellitic dianhydride; PMDA).

A mixture containing 13.5 g CA1, 159.0 g acetone, 7.2 g isooctane, and 0.36 g PMDA was prepared and spray dried as described above to prepare expandable microspheres. T_{Start}, T_{Max}, TMA-density, as well as the volatile content of the obtained expandable microspheres were determined and are shown in Table 7.

TABLE 7
Microsphere properties

| | Anhydride- | | | | |
|---|---|---|---|---|---|
| | containing | Volatile | | | |
| | compound/ | content | | | TMA- |
| | hydrogen | (wt %) | | | density/g |
| Experiment | bond donor | (1) | Tₛₜₐᵣₜ/° C. | Tₘₐₓ/° C. | dm⁻³ |
| 4 | PMDA | 15.5 | 174.2 | 223.4 | 27.7 |

(1) Volatile content of the microspheres, measured by TGA; based on the total weight of the microspheres

A charge of the obtained microspheres was divided into four portions of same size. Three portions were individually subjected to a post heating treatment of 75° C., 100° C., or 125° C. for 1 hour by placing approximately 1 g thereof in an oven set at the respective temperature and one portion was not subjected to a post heating treatment but just left as it was. All portions of the expandable microspheres were then stored at 22.5±2.5° C. and standard pressure (1013±50 mbar), and the volatile content of the expandable microspheres was determined after 1 month, 2 months, and 6 months. In addition, the volatile content of the post heating treated expandable microspheres was also determined directly after the post heating treatment. The results are shown in Table 8.

TABLE 8
Volatile content of expandable microspheres after storage

| | Post | Volatile | Volatile | Volatile | Volatile | |
|---|---|---|---|---|---|---|
| Expandable | heating | content | content | content | content | |
| microspheres | treatment | (wt %) | (wt %) | (wt %) | (wt %) | Percentual |
| from | (yes/no) | before | after 1 | after 2 | after 6 | retention |
| Experiment | [tempera- | storage | month | months | months | [%] |
| No. | ture in ° C.] | (1) | storage | storage | storage | (2) |
| 4 | yes | 14.9 | 14.6 | 14.4 | 12.5 | 83.9 |
| | [75° C.] | | | | | |
| 4 | yes | 14.1 | 14.1 | 13.9 | 13.3 | 94.3 |
| | [100° C.] | | | | | |
| 4 | yes | 13.2 | 13.0 | 13.1 | 13.2 | 100.0 |
| | [125° C.] | | | | | |
| 4 | no | 15.5 | 13.3 | 12.6 | 9.8 | 63.2 |

(1) For the post heating treated expandable microspheres, this value indicates the volatile content after the post heating treatment; for the non-post heating treated expandable microspheres, this value indicates the volatile content after preparation of the microspheres.
(2) The percentual retention indicates how much volatile content after 6 months is retained compared to the volatile content before storage.

As can be seen from Table 8, the post heating treatment can be performed within a wide temperature range and still significantly improves the volatile content of the expandable microspheres.

### Example 4

The influence of different time periods for the post heating treatment was determined using expandable microspheres prepared from CA1 with 1,2,4,5-benzenetetracarboxylic acid (pyromellitic acid; PMA).

A mixture containing 13.5 g CA1, 159.0 g acetone, 7.2 g isooctane, and 0.42 g PMA was prepared and spray dried as described above to prepare expandable microspheres. T_{Start}, T_{Max}, TMA-density, as well as the volatile content of the obtained expandable microspheres were determined and are shown in Table 9.

TABLE 9
Microsphere properties

| | Anhydride- | | | | |
|---|---|---|---|---|---|
| | containing | Volatile | | | |
| | compound/ | content | | | TMA- |
| | hydrogen | (wt %) | | | density/g |
| Experiment | bond donor | (1) | Tₛₜₐᵣₜ/° C. | Tₘₐₓ/° C. | dm⁻³ |
| 5 | PMA | 16.5 | 169.8 | 213.3 | 40.3 |

(1) Volatile content of the microspheres, measured by TGA; based on the total weight of the microspheres

A charge of the obtained microspheres was divided into six portions of same size. Five portions were individually subjected to a post heating treatment of 100° C. for 5 minutes, 15 minutes, 30 minutes, 1 hour, or 2 hours by placing approximately 1 g thereof in an oven set at 100° C. and one portion was not subjected to a post heating treatment but just left as it was. All portions of the expandable microspheres were then stored at 22.5±2.5° C. and standard pressure (1013±50 mbar), and the volatile content of the expandable microspheres was determined after 1 month, 2 months, and 3 months. In addition, the volatile content of the post heating treated expandable microspheres was also determined directly after the post heating treatment. The results are shown in Table 10.

TABLE 10
Volatile content of expandable microspheres after storage

| | | Volatile | Volatile | Volatile | Volatile | |
|---|---|---|---|---|---|---|
| Expandable | Post | content | content | content | content | |
| microspheres | heating | (wt %) | (wt %) | (wt %) | (wt %) | Percentual |
| from | treatment | before | after 1 | after 2 | after 3 | retention |
| Experiment | (yes/no) | storage | month | months | months | [%] |
| No. | [duration] | (1) | storage | storage | storage | (2) |
| 5 | yes | 16.3 | 14.8 | 14.7 | 14.1 | 86.5 |
| | [5 min] | | | | | |
| 5 | yes | 16.0 | 14.8 | 14.6 | 14.2 | 88.8 |
| | [15 min] | | | | | |
| 5 | yes | 15.7 | 14.7 | 14.6 | 14.3 | 91.1 |
| | [30 min] | | | | | |
| 5 | yes | 15.3 | 14.5 | 13.8 | 13.9 | 90.8 |
| | [1 h] | | | | | |
| 5 | yes | 14.8 | 14.2 | 14.1 | 13.7 | 92.6 |
| | [2 h] | | | | | |
| 5 | no | 16.5 | 14.3 | 13.5 | 13.2 | 80.0 |

(1) For the post heating treated expandable microspheres, this value indicates the volatile content after the post heating treatment; for the non-post heating treated expandable microspheres, this value indicates the volatile content after preparation of the microspheres.
(2) The percentual retention indicates how much volatile content after 3 months is retained compared to the volatile content before storage.

As can be seen from Table 10, the post heating treatment can be performed within a wide range of time period and still significantly improves the volatile content of the expandable microspheres.

### Example 5

The influence of the addition of an anhydride-containing compound (i.e. 1,2,4,5-benzenetetracarboxylic dianhydride (pyromellitic dianhydride; PMDA)) or a hydrogen bond donor (i.e. 1,2,4,5-benzenetetracarboxylic acid (pyromellitic acid; PMA)) on storage stability after a post heating treatment was determined.

Mixtures containing CA1, acetone, isooctane and, when appliable, PMDA or PMA in the amounts as specified in Table 11 were prepared and spray dried as described above to prepare expandable microspheres. T_{Start}, T_{Max}, TMA-density, as well as the volatile content of the obtained expandable microspheres were determined and are shown in Table 12.

TABLE 11
Components and amounts for preparing expandable microspheres

| | | Amount of | | | |
|---|---|---|---|---|---|
| | | Anhydride- | | | |
| | Anhydride- | containing | | | |
| | containing | compound/ | Amount | Amount | Amount |
| | compound/ | hydrogen | of | of | of |
| | hydrogen | bond donor | CA1 | acetone | isooctane |
| Experiment | bond donor | [g] | [g] | [g] | [g] |
| 6 | PMDA | 0.12 | 4.5 | 53.0 | 2.4 |
| 7 | PMA | 0.14 | 4.5 | 53.0 | 2.4 |
| 8 | — | — | 4.5 | 53.0 | 2.4 |

— not added

TABLE 12
Microsphere properties

| | Anhydride- | | | | |
|---|---|---|---|---|---|
| | containing | Volatile | | | |
| | compound/ | content | | | TMA- |
| | hydrogen | (wt %) | | | density/g |
| Experiment | bond donor | (1) | Tₛₜₐᵣₜ/° C. | Tₘₐₓ/° C. | dm⁻³ |
| 6 | PMDA | 16.0 | 173.2 | 224.6 | 36.3 |
| 7 | PMA | 16.7 | 169.6 | 212.5 | 40.4 |
| 8 | — | 14.2 | 173.3 | 220.1 | 20.2 |

(1) Volatile content of the microspheres, measured by TGA; based on the total weight of the microspheres
— not added

For each experiment, a charge of each of the obtained microspheres was divided into two portions of same size. For each experiment, one portion was subjected to a post heating treatment of 100° C. for 1 hour by placing approximately 1 g thereof in an oven set at 100° C. and the other portion was not subjected to a post heating treatment but just left as it was. All portions of the expandable microspheres were then stored at 22.5±2.5° C. and standard pressure (1013±50 mbar), and the volatile content of the expandable microspheres was determined after 1 month, 3 months, and 6 months. In addition, the volatile content of the post heating treated expandable microspheres was also determined directly after the post heating treatment. The results are shown in Table 13.

TABLE 13
Volatile content of expandable microspheres after storage

| | | Volatile | Volatile | Volatile | Volatile | |
|---|---|---|---|---|---|---|
| Expandable | | content | content | content | content | |
| microspheres | Post | (wt %) | (wt %) | (wt %) | (wt %) | Percentual |
| from | heating | before | after 1 | after 3 | after 6 | retention |
| Experiment | treatment | storage | month | months | months | [%] |
| No. | (yes/no) | (1) | storage | storage | storage | (2) |
| 6 | yes | 14.6 | 14.5 | 14.6 | 14.6 | 100.0 |
| 6 | no | 16.0 | 14.4 | 13.9 | 12.3 | 76.9 |
| 7 | yes | 15.5 | 15.5 | 15.6 | 15.4 | 99.3 |
| 7 | no | 16.7 | 14.5 | 13.8 | 11.9 | 71.3 |
| 8 | yes | 12.8 | 12.3 | 12.2 | 11.7 | 91.4 |
| 8 | no | 14.2 | 9.0 | 6.4 | 5.1 | 35.9 |

(1) For the post heating treated expandable microspheres, this value indicates the volatile content after the post heating treatment; for the non-post heating treated expandable microspheres, this value indicates the volatile content after preparation of the microspheres.
(2) The percentual retention indicates how much volatile content after 6 months is retained compared to the volatile content before storage.

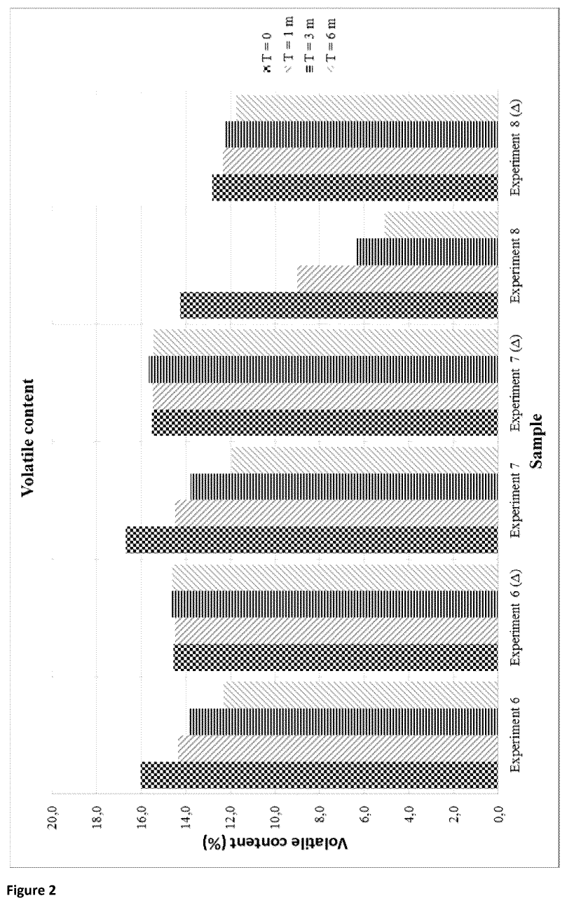

As can be seen from Table 13, the post heating treatment significantly improves the volatile content of the expandable microspheres. With the post heating treatment, a retention of volatiles of up to basically 100 wt % can be achieved even after storage for 6 months whereas the same untreated expandable microspheres have only a remaining volatile content of significantly less than 80 wt %. The results are also visualized in FIG. 2. In FIG. 2, (A) means that the respective sample has been subjected to a post heating treatment. For every experiment, the first column indicates the volatile content before storage, the second column indicates the volatile content after 1 month (1 m) storage, the third column indicates the volatile content after 3 months (3 m) storage, and the fourth column indicates the volatile content after 6 months (6 m) of storage.

What is claimed is:

1. Storage stable thermally expandable microspheres comprising a polymeric shell surrounding a hollow core, wherein the hollow core comprises a blowing agent, and the polymeric shell comprises a carboxylate-functionalised cellulose, wherein the microspheres retain at least 80% of the original weight of blowing agent encapsulated in the microspheres after six months of storage under ambient conditions.

2. The storage stable thermally expandable microspheres of claim 1, wherein the microspheres retain at least 85% of the original weight of blowing agent encapsulated in the microspheres after six months of storage under ambient conditions.

3. The storage stable thermally expandable microspheres of claim 1, wherein the polymeric shell further comprises an anhydride-containing compound or a hydrogen bond donor chosen from alcohols, urea, carboxylic acids, and combinations thereof.

4. The storage stable thermally expandable microspheres according to claim 3, wherein the hydrogen bond donor is chosen from pyromellitic dianhydride (1,2,4,5-benzenetetracarboxylic dianhydride), benzophenone tetracarboxylic dianhydride, pyromellitic acid (1,2,4,5-benzenetetracarboxylic acid), citric acid, tartaric acid, butanetetracarboxylic acid, succinic acid, lactic acid, maleic acid, and any combination thereof.

5. The storage stable thermally expandable microspheres according to claim 1, wherein the carboxylate-functionalised cellulose comprises a carboxylate group of Formula (1) 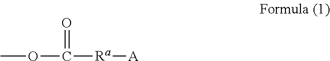
where;
A is chosen from —H, —OH, —OR^{b}, —C(O)OH and —C(O)OR^{b};
R^{a} is absent such that A is directly attached to the C═O group; or R^{a} is chosen from saturated or unsaturated aliphatic groups having from 1 to 11 carbon atoms, which can be linear, branched or cyclic; and from 5- and 6-membered aromatic rings; wherein R^{a} is optionally substituted with one or more substituents chosen from —OH, halide, C₁₋₄ alkyl, and C₁₋₄ alkoxy, in which the C₁₋₄ alkyl and C₁₋₄ alkoxy groups are optionally substituted with one or more groups chosen from halide and —OH; and
R^{b} on each occurrence is independently chosen from a C₁₋₄ alkyl group, optionally with one or more substituents chosen from halide and —OH groups.

6. The storage stable thermally expandable microspheres according claim 1, wherein one or more of the following conditions apply:
(a) A is chosen from H and C(O)OH;
(b) R^{a} comprises from 1 to 7 carbon atoms;
(c) R^{a} is chosen from (i) saturated linear or branched aliphatic CᵥR₂ᵥ^{c} groups;
(ii) cyclic C_{w}R_{2w-2}^{c} aliphatic groups, (iii) unsaturated linear or branched aliphatic CₓR_{2x-2y}^{c} groups comprising “y” double bonds; (iv) unsaturated cyclic aliphatic C_{w}R_{2w-2y-2}^{c} group comprising “y” double bonds; and (v) C_{z}R_{z-2}^{c} aromatic groups where;
v is an integer of from about 1 to about 11;
w is an integer of from about 3 to about 11;
x is an integer of from about 2 to about 11;
y is 1 or 2;
z is 5 or 6 and
R^{c} on each occurrence is independently chosen from H, —OH, halide, C₁₋₄ alkyl, and C₁₋₄ alkoxy, where the C₁₋₄ alkyl and C₁₋₄ alkoxy groups are optionally substituted with one or more groups chosen from halide and —OH;
(d) R^{a} is chosen from CₚR_{2p-2q}^{c}−E−CᵣR₂ᵣ₋₂ₛ^{c} groups having no more than 11 carbon atoms, where;
E is C_{w}R_{2w-2}^{c}, C_{w}R_{2w-2y-2}^{c}, or C_{z}R_{z-2}^{c} as defined in (c) above;
p and r are each independently a whole number from 0 to 8, and p+r is at least 1;
q and s are each the number of double bonds in the respective non-cyclic aliphatic component, each independently chosen from 0, 1 and 2.

7. The storage stable thermally expandable microspheres according to claim 1, wherein the carboxylate-functionalised cellulose comprises a carboxylate functionality chosen from optionally substituted C₁-C₈ aliphatic carboxylate groups and carboxylate groups comprising an optionally substituted C₆ aromatic ring.

8. The storage stable thermally expandable microspheres according to claim 1, wherein the carboxylate-functionalised cellulose is acetate-functionalised cellulose, propionate-functionalised cellulose, or butyrate-functionalised cellulose.

9. The storage stable thermally expandable microspheres according to claim 8, wherein the carboxylate-functionalised cellulose has a number average molecular weight (Mₙ) of from about 2,000 to about 100,000 Da.

10. Method for preparing storage stable thermally expandable microspheres comprising a polymeric shell surrounding a hollow core, wherein the hollow core comprises a blowing agent, and the polymeric shell comprises a carboxylate-functionalised cellulose, the method comprising the following steps:
(i) preparing thermally expandable microspheres comprising a polymeric shell surrounding a hollow core, wherein the hollow core comprises a blowing agent, and the polymeric shell comprises a carboxylate-functionalised cellulose; and
(ii) subjecting the thermally expandable microspheres obtained in step (i) to a post heating treatment by heating the thermally expandable microspheres to a temperature of at least 40° C.

11. The method of claim 10, wherein the post heating treatment is performed at a temperature of from 50° C. to 150° C.

12. The method of claim 10, wherein the post heating treatment is performed for at least 5 minutes.

13. The method according to claim 10 comprising a further step of
(iii) cooling the thermally expandable microspheres obtained in step (ii) to a temperature below the temperature used in step (ii).

14. The method according to claim 10 comprising a further step of
(iv) storing the thermally expandable microspheres obtained in step (ii) or, if performed, step (iii) for at least 10 minutes.

15. Storage stable thermally expandable microspheres obtained by the method according to claim 10.
